(19) United States
(12) Patent Application Publication
(10) Pub. No.: US 2013/0293810 A1
(43) Pub. Date: Nov. 7, 2013

(54) LIGHTING DEVICE, LIGHT UNIT AND LIQUID CRYSTAL DISPLAY

(71) Applicant: ROHM CO., LTD., Kyoto-shi (JP)

(72) Inventors: Wei-Chih KE, New Taipei City (TW); Kun-Hung HSIEH, Kaohsiung City (TW); Hiroyoshi SAKAGUCHI, Kyoto-shi (JP)

(21) Appl. No.: 13/849,844

(22) Filed: Mar. 25, 2013

(30) Foreign Application Priority Data
Mar. 26, 2012 (JP) 2012-69457
Jun. 29, 2012 (JP) 2012-147677
Aug. 1, 2012 (JP) 2012-170965

(51) Int. Cl. F21V 9/10; G02F 1/1335

(52) U.S. Cl. CPC F21V 9/10; G02F 1/133621; G02F 1/133615
USPC 349/65; 362/311.02; 362/307; 362/223; 362/293; 349/69

(57) ABSTRACT

A lighting device includes a support member provided with a wiring portion. The lighting device further includes an LED light source placed on the wiring portion, and an insulating layer. The insulating layer is provided on the wiring portion except a region at which the LED light source is placed. The LED light source is covered by a light-transmitting resin portion. A fluorescent substance is dispersed in the light-transmitting resin portion. The fluorescent substance is a sulfide-based fluorescent material.

### BACKGROUND OF THE INVENTION

1. Field of the Invention

The present invention relates to a lighting device, alight unit a liquid crystal display.

2. Description of the Related Art

Conventionally, liquid crystal displays are used for e.g. monitors of notebook computers or monitors of liquid crystal display televisions. Liquid crystal displays are known which employ light emitting diodes (LEDs) for the backlights (see e.g. JP-A-2011-77084). The LED lighting apparatus disclosed in this document includes a substrate, a plurality of bear chip LEDs and a light-transmitting member. The bear chip LEDs are arranged at regular intervals along the longitudinal direction of the substrate. Each bear chip LED emits blue light. The light-transmitting member covers the bear chip LEDs. The light-transmitting member contains a YAG-based fluorescent material. This fluorescent material is a yellow fluorescent substance and emits yellow light when excited by blue light. When the bear chip LEDs emit blue light, the blue light from the bear chip LEDs and the yellow light from the fluorescent material mix with each other, whereby white light is emitted from the LED lighting apparatus.

FIG. 25 shows the light emission spectrum of a conventional LED lighting apparatus using bear chip LEDs that emit blue light and a YAG-based yellow fluorescent substance. The horizontal axis of the figure shows the wavelength, whereas the vertical axis of the figure shows the intensity. In the spectrum of this figure, the green range (wavelength: 500-565 nm) and the red range (wavelength: 625-740 nm) are not clearly distinguishable from each other. Moreover, the intensity in the red range is not sufficient. With this light emission spectrum, a sufficiently wide range of color cannot be reproduced. When the range of color that can be reproduced is not sufficiently wide, the liquid crystal display cannot show various colors close to natural colors.

As an indicator for the reproducibility of color gamut, the NTSC (National Television System Committee) ratio is known. The conventional LED lighting apparatus with the light emission spectrum of FIG. 15 provides a relatively low NTSC ratio of about 70%.

### SUMMARY OF THE INVENTION

The present invention has been proposed under the circumstances described above. It is therefore amain object of the present invention to provide a lighting device that reproduces a wider range of color than is conventionally possible.

According to a first aspect of the present invention, there is provided a lighting device comprising a support member including a wiring portion, an LED light source placed on the wiring portion, an insulating layer provided on the wiring portion except a region at which the LED light source is placed, a light-transmitting resin portion covering the LED light source, and a fluorescent substance dispersed in the light-transmitting resin portion. The fluorescent substance comprises a sulfide-based fluorescent material.

Preferably, the insulating layer surrounds the LED light source.

Preferably, the insulating layer is covered by the light-transmitting resin portion.

Preferably, the LED light source includes a chip base and an LED chip mounted on the chip base.

Preferably, the chip base is a sub-mount substrate made of Si.

Preferably, the chip base has a side surface oriented in a direction perpendicular to a thickness direction of the support member, the insulating layer is made of a material having a reflectance higher than the reflectance of a material forming the chip base, and the insulating layer covers at least part of the side surface.

Preferably, the insulating layer covers the entirety of the side surface.

Preferably, the insulating layer is spaced apart from the LED chip.

Preferably, the LED light source is an LED chip.

Preferably, the insulating layer includes a light reflective surface that is in direct contact with the light-transmitting resin portion.

Preferably, the insulating layer is white.

Preferably, the insulating layer is transparent.

Preferably, the wiring portion includes a first layer in contact with the insulating layer, and the first layer is made of Ag or Au.

Preferably, the wiring portion includes a second layer, the first layer is positioned between the second layer and the insulating layer, and the second layer is made of Cu.

Preferably, the lighting device further comprises a frame bonded to the support member and surrounding the LED light source.

Preferably, the insulating layer is in direct contact with the frame.

Preferably, the light-transmitting resin portion is in direct contact with the frame.

Preferably, the frame includes an inner surface surrounding the LED light source, and the inner surface is inclined with respect to the thickness direction in such a manner as to become more distant from the LED light source as viewed in the thickness direction as becoming more distant from the support member in the thickness direction.

Preferably, the lighting device further comprises a frame bonding layer that bonds the frame to the support member, and the frame bonding layer is in direct contact with the frame.

Preferably, the lighting device further comprises an insulating protective layer covering the wiring portion. The protective layer includes an opening for exposing the wiring portion, and the LED light source is arranged in the opening.

Preferably, the lighting device further comprises a wire that is in direct contact with both of the LED light source and the wiring portion, and at least part of the wire is directly covered by the insulating layer.

Preferably, the lighting device further comprises an LED bonding layer that bonds the LED light source and the wiring portion together, and the LED bonding layer is in direct contact with both of the LED light source and the wiring portion.

Preferably, the LED bonding layer is directly covered by the insulating layer.

Preferably, the support member is elongated in one direction, and the LED light source comprises a plurality of LED light sources arranged on the support member along the longitudinal direction of the support member.

Preferably, the fluorescent substance emits light of a different wavelength from a wavelength of light emitted from the LED light source when excited by light from the LED light source.

Preferably, the sulfide-based fluorescent material contains at least one sulfide selected from the group consisting of calcium sulfide (CaS), zinc sulfide (ZnS), strontium sulfide (SrS), strontium thiogallate (SrGa₂S₄) and calcium thiogallate (CaGa₂S₄).

Preferably, the sulfide-based fluorescent material that forms the fluorescent substance is a material doped with at least one element selected from the group consisting of Eu, Tb, Sm, Pr, Dy and Tm.

Preferably, the fluorescent substance includes a red fluorescent substance and a green fluorescent substance, and each of the red fluorescent substance and the green fluorescent substance comprises a sulfide-based fluorescent material.

Preferably, the red fluorescent substance comprises any one of calcium sulfide doped with europium (CaS:Eu), zinc sulfide doped with europium (ZnS:Eu) and strontium sulfide (SrS:Eu) doped with europium.

Preferably, the green fluorescent substance comprises strontium thiogallate doped with europium (SrGa₂S₄:Eu) or calcium thiogallate doped with europium (CaGa₂S₄:Eu).

Preferably, the LED light source emits blue light.

Preferably, the LED light source serves as a first LED light source, the lighting device further comprises a second LED light source placed on the wiring portion, and the first LED light source emits blue light whereas the second LED light source emits red light.

Preferably, the insulating layer is provided on the wiring portion except a region at which the first LED light source is placed and a region at which the second LED light source is placed.

Preferably, the fluorescent substance includes a green fluorescent substance, and the green fluorescent substance comprises a sulfide-based fluorescent material.

Preferably, the green fluorescent substance comprises strontium thiogallate doped with europium (SrGa₂S₄:Eu) or calcium thiogallate doped with europium (CaGa₂S₄:Eu).

Preferably, the light-transmitting resin portion covers the second LED light source.

Preferably, the support member includes a base on which the wiring portion is provided, the base includes an electrically conductive substrate and an insulating film formed on the substrate, and the wiring portion is formed on the insulating film.

According to a second aspect of the present invention, there is provided a light unit comprising the lighting device provided according to the first aspect of the present invention, a base, and an electrically conductive bonding layer that is provided between the support member and the base and bonds the support member and the base together.

Preferably, the base is elongated in one direction.

Preferably, the electrically conductive bonding layer is solder or silver paste.

According to a third aspect of the present invention, there is provided a liquid crystal display comprising the lighting device provided according to the first aspect of the present invention, and a liquid crystal panel for forming an image by selectively transmitting light emitted from the lighting device.

Preferably, the liquid crystal display further comprises a light guide plate including a light incident surface, a reflective surface and a light emitting surface. The light incident surface spreads along a plane parallel to a thickness direction of the light guide plate and faces the lighting device. The reflective surface reflects light traveling from the light incident surface toward the light emitting surface. The light emitting surface allows light reflected by the reflective surface to be emitted toward the liquid crystal panel.

Preferably, the lighting device comprises a plurality of lighting devices, and the lighting devices are arranged along one direction and face the liquid crystal panel.

Other features and advantages of the present invention will become more apparent from detailed description given below with reference to the accompanying drawings.

### BRIEF DESCRIPTION OF THE DRAWINGS

FIG. 1 is a perspective view of a liquid crystal display according to a first embodiment of the present invention;

FIG. 2 is a sectional view taken along lines II-II in FIG. 1;

FIG. 3 is a perspective view of the lighting device shown in FIGS. 1 and 2;

FIG. 4 is an exploded perspective view of the lighting device shown in FIG. 3;

FIG. 5 is a perspective view of the lighting device shown in FIG. 4, with the illustration of frames and a protective layer omitted.

FIG. 6 is a perspective view of the lighting device shown in FIG. 5, with the illustration of LED light sources omitted.

FIG. 7 is an enlarged plan view of a portion of the lighting device shown in FIG. 3;

FIG. 8 is a plan view of the lighting device shown in FIG. 7, with the illustration of a frame and an insulating layer omitted.

FIG. 9 is a plan view of the lighting device shown in FIG. 8, with the illustration of a protective layer omitted.

FIG. 10 is a sectional view taken along lines X-X in FIG. 7;

FIG. 11 is a graph showing the light emission spectrum of the light from the lighting device according to the first embodiment of the present invention;

FIG. 12 is a sectional view of a lighting device according to a first variation of the first embodiment of the present invention;

FIG. 13 is a sectional view of a lighting device according to a second variation of the first embodiment of the present invention;

FIG. 14 is a plan view of a lighting device according to a second embodiment of the present invention;

FIG. 15 is a sectional view taken along lines XV-XV in FIG. 14;

FIG. 16 is a sectional view of a liquid crystal display according to a third embodiment of the present invention;

FIG. 17 is a sectional view of the lighting device shown in FIG. 16;

FIG. 18 is an exploded perspective view of a lighting device according to a fourth embodiment of the present invention;

FIG. 19 is an enlarged plan view of part of the lighting device according to a fourth embodiment of the present invention;

FIG. 20 is a sectional view taken along lines XX-XX in FIG. 19;

FIG. 21 is a sectional view taken along lines XXI-XXI in FIG. 19;

FIG. 22 is a perspective view of a lighting device according to a fifth embodiment of the present invention;

FIG. 23 is a sectional view of the lighting device according to the fifth embodiment of the present invention;

FIG. 24 is a sectional view of a light unit according to the fifth embodiment of the present invention; and

FIG. 25 is a graph showing the light emission spectrum of the light from a conventional lighting device.

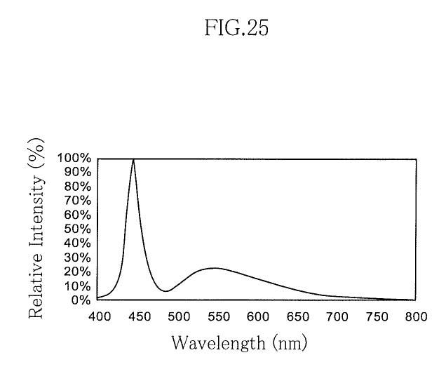

### DESCRIPTION OF THE PREFERRED EMBODIMENTS

Preferred embodiments of the present invention are described below with reference to the accompanying drawings.

### First Embodiment

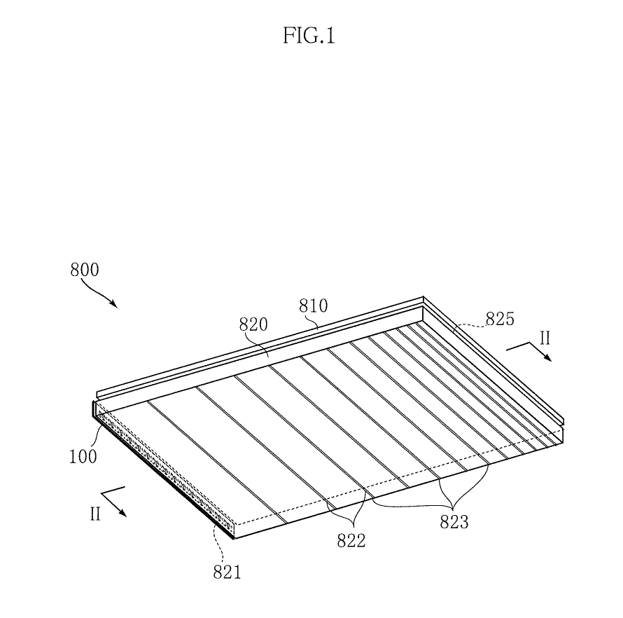

A first embodiment of the present invention is described below with reference to FIGS. 1-11.

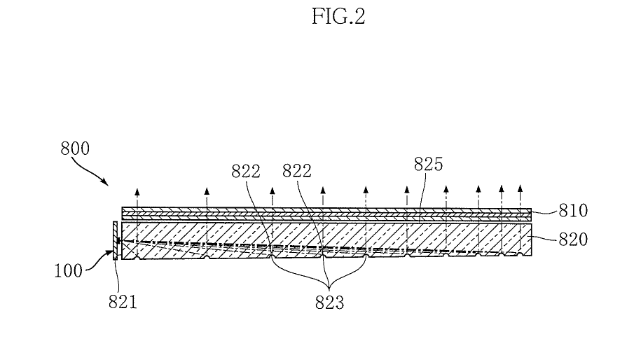

FIG. 1 is a perspective view of a liquid crystal display according to a first embodiment of the present invention. FIG. 2 is a sectional view taken along lines II-II in FIG. 1.

The liquid crystal display 800 shown in the figures may be a monitor of a notebook computer or a monitor of a liquid crystal display television. The liquid crystal display 800 includes a liquid crystal panel 810, a light guide plate 820 and a lighting device 100.

The light guide plate 820, along with the lighting device 100, provides a backlight of the liquid crystal panel 810. The light guide plate 820 is made of a transparent material. Examples of a transparent material for the light guide plate 820 include polycarbonate resin or acrylic resin. The light guide plate 820 includes a light incident surface 821, a reflective surface 822 and a light emitting surface 825. The light incident surface 821 spreads along a plane that is parallel to the thickness direction of the light guide plate 820. The light incident surface 821 faces the lighting device 100. The reflective surface 822 reflects the light traveling from light incident surface 821 toward the light emitting surface 825. In this embodiment, the light guide plate 820 has a plurality of grooves 823. The grooves 823 provide the reflective surface 822. The light emitting surface 825 allows the light reflected by the reflective surface 822 to be emitted toward the liquid crystal panel 810. Thus, when the lighting device 100 emits light, light is emitted from the entire light emitting surface 825 of the light guide plate 820.

The liquid crystal panel 810 selectively transmits the light emitted from the lighting device 100 to form an image. In this embodiment, the liquid crystal panel 810 selectively allows the light emitted from the lighting device 100 and then emitted from the light guide plate 820 to pass through, thereby forming an image. For instance, the liquid crystal panel 810 includes two transparent substrates and a liquid crystal layer. The liquid crystal layer is sandwiched between the two transparent substrates. For instance, the liquid crystal panel 810 is designed to appropriately change the light transmission state of each pixel by the active matrix method.

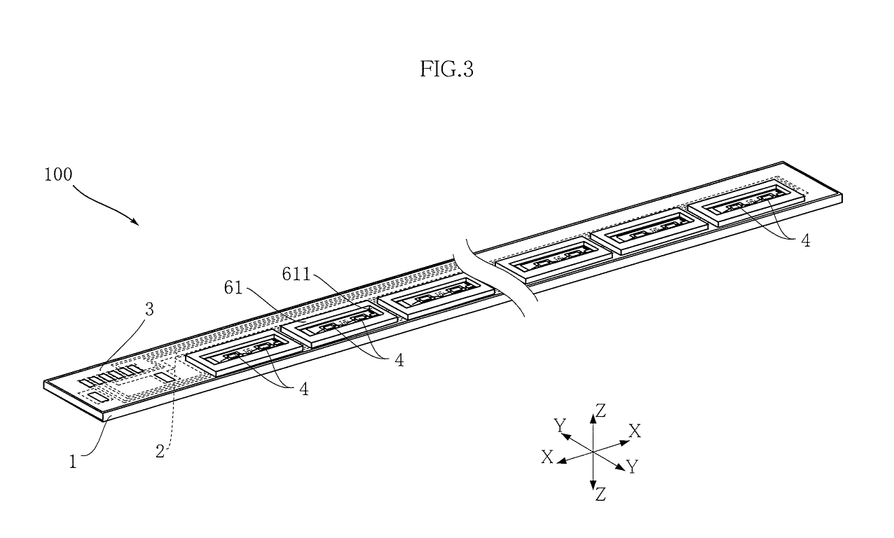

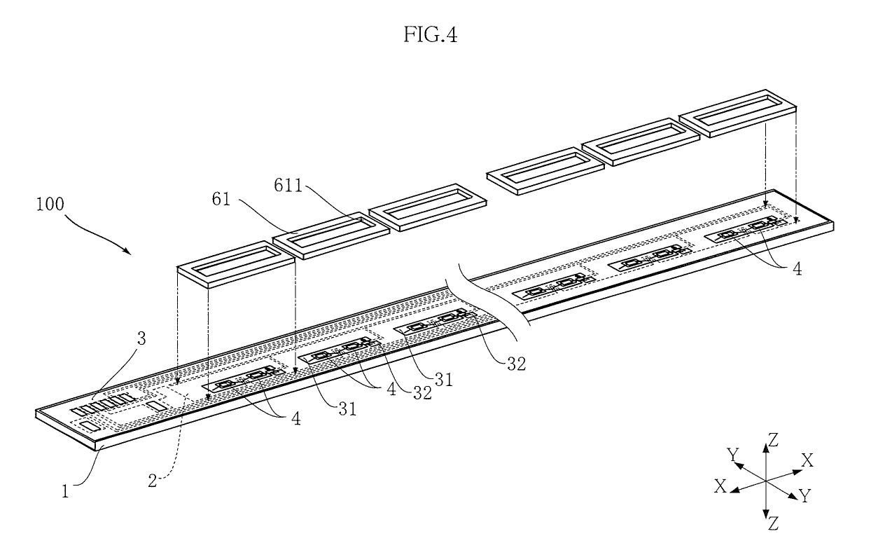

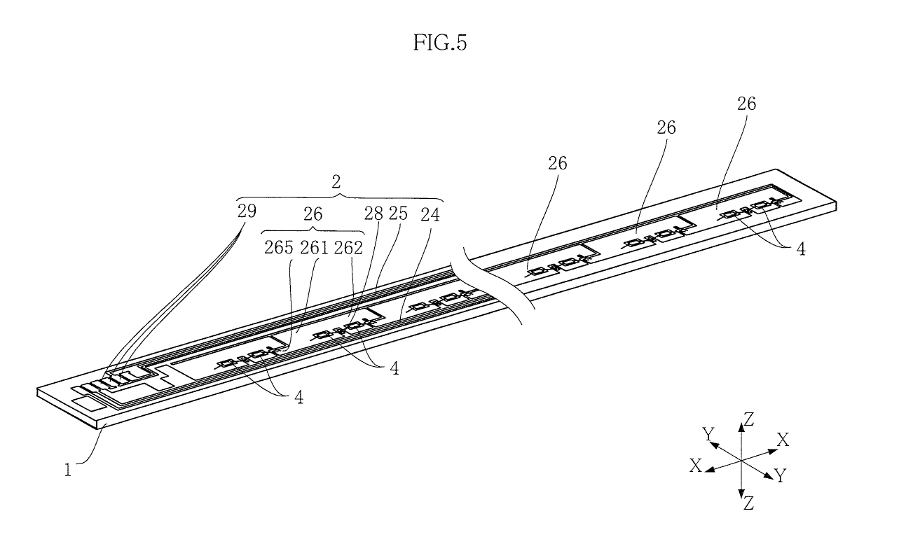

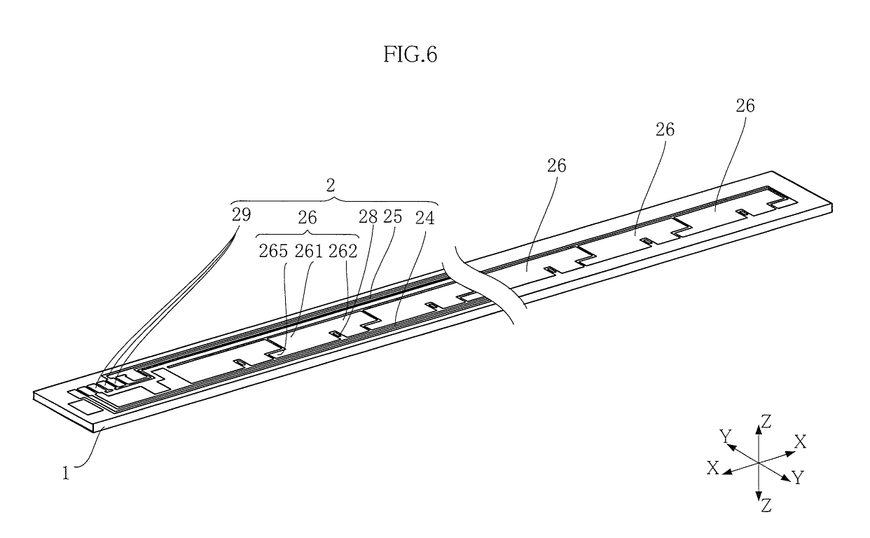

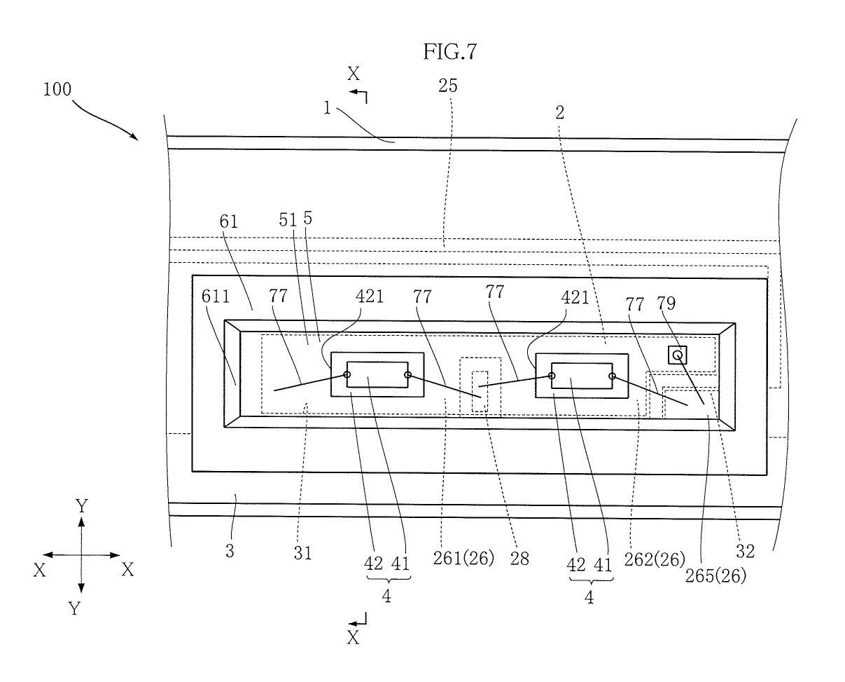

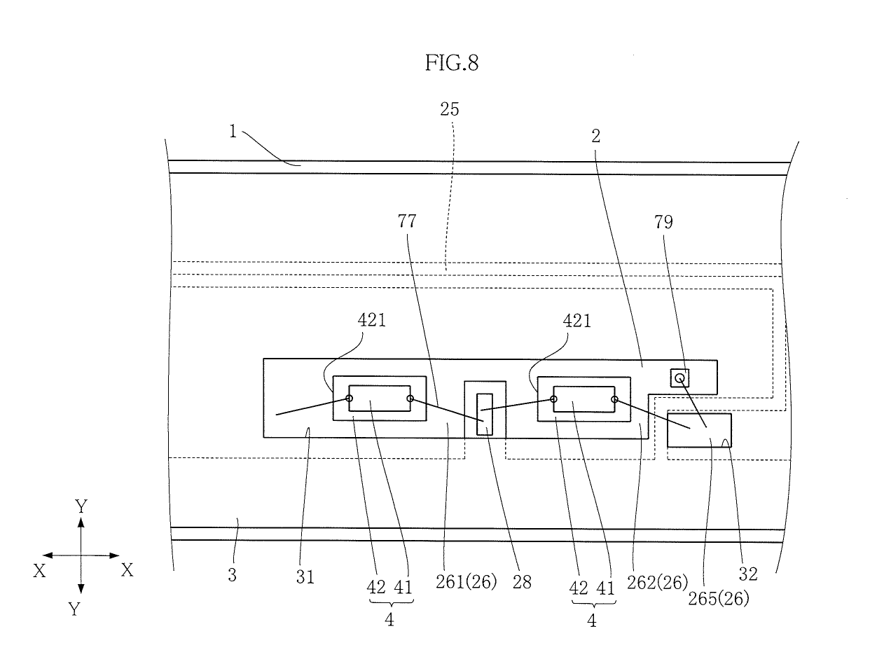

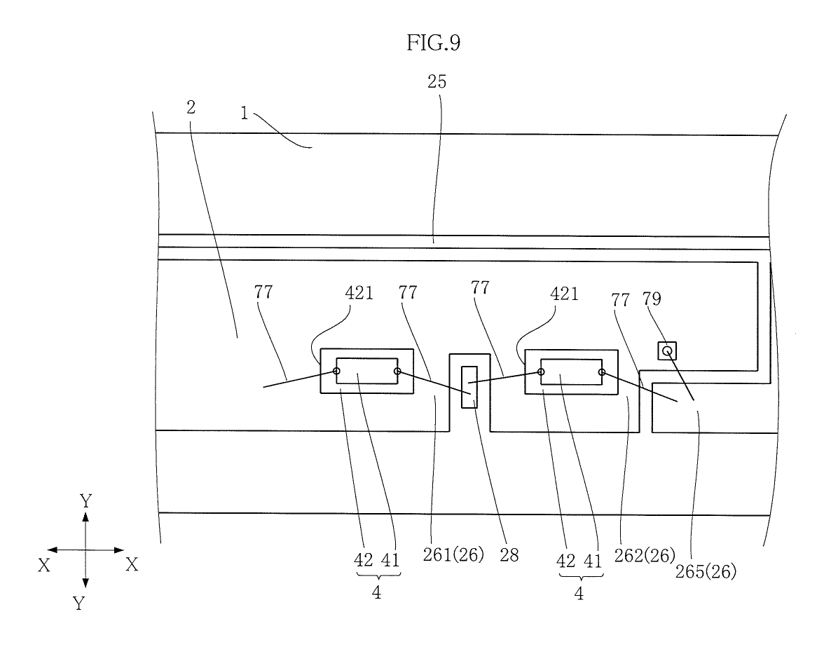

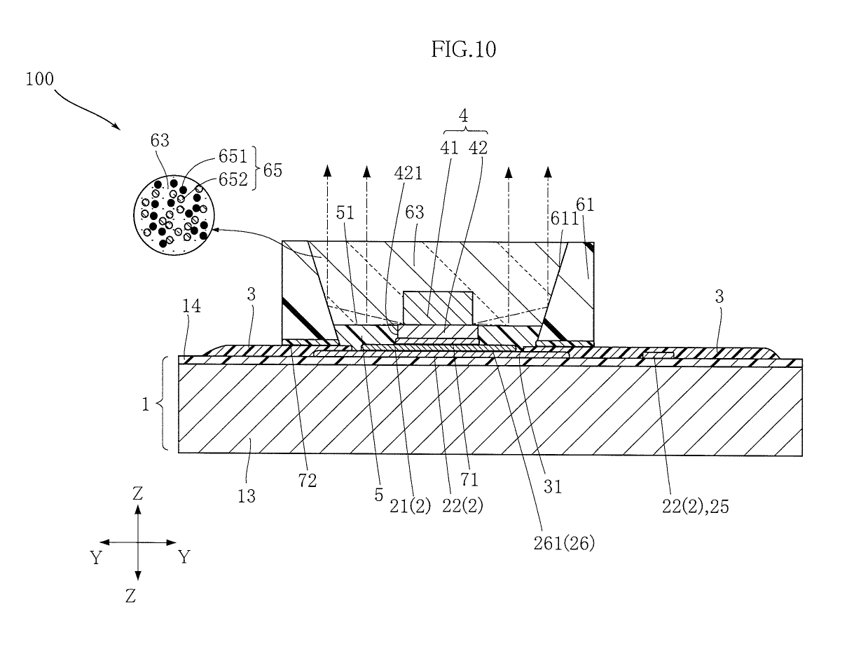

FIG. 3 is a perspective view of the lighting device shown in FIGS. 1 and 2. FIG. 4 is an exploded perspective view of the lighting device shown in FIG. 3. FIG. 5 is a perspective view of the lighting device shown in FIG. 4, with the illustration of frames and a protective layer omitted. FIG. 6 is a perspective view of the lighting device shown in FIG. 5, with the illustration of LED light sources omitted. FIG. 7 is an enlarged plan view of a portion of the lighting device shown in FIG. 3. FIG. 8 is a plan view of the lighting device shown in FIG. 7, with the illustration of a frame and an insulating layer omitted. FIG. 9 is a plan view of the lighting device shown in FIG. 8, with the illustration of a protective layer omitted. FIG. 10 is a sectional view taken along lines X-X in FIG. 7.

The lighting device 100 shown in these figures includes a base 1, a wiring portion 2, a protective layer 3, LED light sources 4, insulating layers 5 (see FIG. 10), frames 61, light-transmitting resin portions 63 (see FIG. 10), a fluorescent substance 65 (see FIG. 10), light source bonding layers 71 (see FIG. 10), frame bonding layers 72 (see FIG. 10) and wires 7. For easier understanding, illustration of the light-transmitting resin portions 63, light source bonding layers 71 and frame bonding layers 72 is omitted in FIGS. 3 and 4. For easier understanding, illustration of the light-transmitting resin portions 63 is omitted in FIG. 7. The base 1 and the wiring portion 2 provide a support member.

The base 1 is provided for disposing the LED light sources 4. In this embodiment, the base 1 is elongated in one direction. The dimension of the base 1 in the longitudinal direction X is e.g. about 222 mm, and the dimension of the base 1 in the width direction Y is e.g. about 6.0 mm. The dimension of the support member (which is made up of the base 1 and the wiring portion 2 in this embodiment) in the thickness direction Z is e.g. about 1.0 mm.

As shown in FIG. 10, in this embodiment, the base 1 includes a substrate 13 and an insulating film 14.

The substrate 13 is made of an electrically conductive material. Examples of electrically conductive material for forming the substrate 13 include Al, Cu and Fe. In this embodiment, the substrate 13 is made of Al.

The insulating film 14 is formed on the substrate 13. For instance, the insulating film 14 may be epoxy resin, glass epoxy resin or polyimide resin. The insulating film 14 prevents the wiring portion 2 and the substrate 13 from being electrically connected to each other.

Unlike this embodiment, the entirety of the base 1 may be made of an insulating material. Examples of such an insulating material include a ceramic material or an insulating resin. Examples of ceramic material include Al₂O₃, SiC and AlN. Examples of insulating resin include glass epoxy resin.

The wiring portion 2 is provided on the base 1. The wiring portion 2 functions to supply electric power to the LED light sources 4. As shown in FIG. 10, in this embodiment, the wiring portion 2 is formed on the insulating film 14 of the base 1. That is, the insulating film 14 is positioned between the wiring portion 2 and the substrate 13.

As shown in FIG. 10, the wiring portion 2 includes a first layer 21 and a second layer 22.

The first layer 21 is the upper layer of the wiring portion 2 in FIG. 10. The first layer 21 is provided for making it easier to bond of the LED light sources 4 and the wires 77 to the wiring portion 2. The first layer 21 is in contact with an insulating layer 5, which will be described later. The second layer 22 is formed directly on the base 1. The second layer 22 is positioned between the first layer 21 and the base 1.

In this embodiment, the second layer 22 is formed directly on the insulating film 14 of the base 1. Part of the second layer 22 is not covered by the first layer 21. That is, part of the second layer 22 is exposed out of the first layer 21.

Both of the first layer 21 and the second layer 22 are made of an electrically conductive material. For instance, the first layer 21 is made of Ag or Au. For instance, the second layer 22 is made of Cu, Au or Ag.

As shown in FIGS. 5 and 6, the wiring portion 2 has a predetermined pattern in plan view of the base 1. The pattern of the wiring portion 2 can be varied appropriately. An example of the pattern shape of the wiring portion 2 is described below. Specifically, the wiring portion 2 includes first strip portions 24, second strip portions 25, a plurality of island portions 26, a plurality of wire bonding portions 28, and a plurality of connection terminal portions 29.

As shown in FIGS. 5 and 6, each first strip portion 24 includes a portion elongated in the longitudinal direction X. The width of each first strip portion 24 is e.g. about 1 mm. Each first strip portion 24 is positioned adjacent to one of the two edges of the base 1 which are spaced from each other in the width direction Y. In this embodiment, each first strip portion 24 comprises only the second layer 22.

Each second strip portion 25 includes a portion elongated in the longitudinal direction X. The width of each second strip portion 25 is e.g. about 1 mm. Each second strip portion 25 is positioned adjacent to the other one of the two edges of the base 1 which are spaced from each other in the width direction Y. As shown in FIG. 10, in this embodiment, each second strip portion 25 comprises only the second layer 22.

As shown in FIGS. 5 and 6, the island portions 26 are arranged along the longitudinal direction X. As shown in FIG. 10, in this embodiment, each island portion 26 includes a portion that comprises only the second layer 22 and a portion that comprises lamination of the first layer 21 and the second layer 22.

As shown in FIGS. 5, 6 and 9, each island portion 26 includes a first die bonding pad 261, a second die bonding pad 262, and a wire bonding pad 265.

The first die bonding pad 261 is in the form of a rectangle elongated in the longitudinal direction X. The second die bonding pad 262 has a rectangular shape with its lower right portion in FIG. 9 cut out. The second die bonding pad 262 is electrically connected to the first die bonding pad 261. The wire bonding pad 265 extends from the first die bonding pad 261 to the left in FIG. 9. The wire bonding pad 265 is connected to the first die bonding pad 261.

As shown in FIGS. 5 and 6, the connection terminal portions 29 are positioned adjacent to one of the two ends of the base 1 which are spaced from each other in the longitudinal direction X. The connection terminal portions 29 are used for connection to a power supply (not shown) or a control unit (not shown) of the liquid crystal display 800. Each connection terminal portion 29 is electrically connected to a corresponding island portion 26 via a first strip portion 24 or a second strip portion 25.

The protective layer 3, which is shown in FIGS. 3, 4, 7, 8 and 10, has insulating property and covers the wiring portion 2. For instance, the protective layer 3 may comprise a solder resist layer. The protective layer 3 has openings for exposing the wiring portion 2. As shown in FIGS. 4 and 8, in this embodiment, the protective layer 3 has a plurality of first openings 31 and a plurality of second openings 32. In this embodiment, both of the first openings 31 and the second openings 32 are rectangular. The shape of the first openings 31 and the second openings 32 is not limited to this and may be circular or other shapes. The area of each first opening 31 is larger than the area of each second opening 32. As shown in FIG. 8, the first openings 31 and the second openings 32 expose the island portions 26 and the wire bonding portions 28 of the wiring portion 2. Specifically, the first openings 31 expose the first die bonding pads 261 and the second die bonding pads 262 of the island portions 26 and the wire bonding portions 28. The second openings 32 expose the wire bonding pads 265 of the island portions 26. As shown in FIGS. 3 and 4, several of the openings of the protective layer 3 other than the first openings 31 and the second openings 32 expose connection terminal portions 29. The LED light sources 4, which are shown in FIGS. 3-5 and FIGS. 7-10, are placed on the wiring portion 2. The LED light sources 4 are arranged along the longitudinal direction X of the base 1. For instance, the arrangement pitch of the LED light sources 4 is 2.0-20 mm. The dimension of each LED light source 4 in the longitudinal direction X is e.g. about 1.9 mm, whereas the dimension of each LED light source in the direction Y is e.g. about 1.3 mm. As shown in FIG. 8, in this embodiment, the LED light sources 4 are placed on the island portions 26. Each of the LED light sources 4 is placed on a first die bonding pad 261 or a second die bonding pad 262. On each second die bonding pad 262, a Zener diode 79 is bonded. The Zener diode 79 prevents excessive reverse voltage from being applied to an LED chip 41.

As better shown in FIG. 10, each LED light source 4 includes an LED chip 41 and a chip base 42.

Each LED chip 41 is a bear chip LED. In this embodiment, each LED chip 41 emits blue light. The LED chip 41 includes an n-type semiconductor layer, an active layer and a p-type semiconductor layer. The n-type semiconductor layer is on the active layer. The active layer is on the p-type semiconductor layer. The active layer is positioned between the n-type semiconductor layer and the p-type semiconductor layer. For instance, the n-type semiconductor layer, the active layer and the p-type semiconductor layer are made of GaN. Each LED chip 41 has two electrode pads (not shown).

Each LED chip 41 is mounted on a chip base 42. In this embodiment, the chip base 42 is a sub-mount substrate made of Si. Unlike this embodiment, the chip base 42 may not be a sub-mount substrate made of Si but may be a substrate made of Al. The chip base 42 is provided with a wiring portion (not shown). To the wiring portion of the chip base 42 is bonded an electrode pad of the LED chip 41. As shown in FIGS. 7 and 10, the chip base 42 has a side surface 421. The side surface 421 is oriented in the direction perpendicular to the thickness direction Z.

Several of the wires 77 shown in FIG. 8 and so on are in direct contact with both of the LED light sources 4 and the wiring portion 2, thereby electrically connecting the LED light sources 4 and the wiring portion 2. Specifically, the wires 77 electrically connect the LED light sources 4 and the first die bonding pads 261, the LED light sources 4 and the wire bonding portions 28, the LED light sources 4 and the wire bonding pads 265, and the Zener diodes 79 and the wire bonding pads 265.

The insulating layer 5 shown in FIGS. 7 and 10 covers the wiring portion 2 except some regions at which the LED light sources 4 are placed. As viewed in the thickness direction Z, the insulating layer 5 surrounds the LED light source 4. The insulating layer 5 is in direct contact with the wiring portion 2. Specifically, the insulating layer 5 is in direct contact with the first layer 21 of the wiring portion 2.

In this embodiment, the insulating layer 5 is made of a material having a reflectance higher than that of the material forming the chip base 42 and that does not transmit the light from the LED light source 4. In this embodiment, examples of the material for forming the insulating layer 5 include epoxy resin and silicone resin. In this embodiment, the insulating layer 5 is white.

The insulating layer 5 covers at least part of the side surface 421 of the chip base 42. In this embodiment, as shown in FIGS. 7 and 10, the insulating layer 5 covers the entirety of the side surface 421 of the chip base 42. The insulating layer 5 does not cover the LED chip 41. That is, the insulating layer 5 is spaced apart from the LED chip 41. The insulating layer 5 does not necessarily need to cover the entire side surface 421. Unlike this embodiment, part of the side surface 421 may be exposed from the insulating layer 5. The insulating layer 5 directly covers at least part of the wire 77 (covers only a part, in this embodiment).

As shown in FIG. 10, the insulating layer 5 has a light reflective surface 51. The light reflective surface 51 is in direct contact with the light-transmitting resin portion 63. The light reflective surface 51 reflects the light emitted from the LED light source 4. Thus, the light emitted from the LED light source 4 does not reach the wiring portion 2.

As shown in FIG. 10, the light-transmitting resin portion 63 covers the insulating layer 5 and the LED light source 4. The light-transmitting resin portion 63 transmits the light emitted from the LED light source 4. In this embodiment, the light-transmitting resin portion 63 is made of a transparent resin. Examples of such transparent resin include epoxy resin, silicone resin and polyvinyl-based resin. As viewed in the thickness direction Z, the light-transmitting resin portion 63 overlaps both of the LED light source 4 and the insulating layer 5.

As shown in FIG. 10, the fluorescent substance 65 is dispersed in the light-transmitting resin portion 63. The fluorescent substance 65 is made of a sulfide-based fluorescent material. When excited by the light emitted from the LED light source 4, the fluorescent substance 65 emits light having a wavelength different from that of the light emitted from the LED light source 4. The light emitted from the LED light source 4 and the light emitted from the fluorescent substance 65 mix together, whereby white light is emitted from the lighting device 100. The light-transmitting resin portion 63, in which the fluorescent substance 65 is dispersed, does not necessarily need to be in direct contact with the LED light source 4 but may be spaced apart from the LED light source 4.

The sulfide-based fluorescent material to form the fluorescent substance 65 contains at least one sulfide selected from the group consisting of calcium sulfide (CaS), zinc sulfide (ZnS), strontium sulfide (SrS), strontium thiogallate (SrGa₂S₄), and calcium thiogallate (CaGa₂S₄). Also, the sulfide-based fluorescent material is doped with at least one element selected from the group consisting of Eu, Tb, Sm, Pr, Dy and Tm.

In this embodiment, the fluorescent substance 65 includes a red fluorescent substance 651 and a green fluorescent substance 652.

In this embodiment, each of the red fluorescent substance 651 and the green fluorescent substance 652 comprises a sulfide-based fluorescent material. The red fluorescent substance 651 emits red light when excited by blue light. The peak of the wavelength of the light emitted from the red fluorescent substance 651 is 625-740 nm. For instance, the red fluorescent substance 651 comprises any one of calcium sulfide doped with europium (CaS:Eu), zinc sulfide doped with europium (ZnS:Eu) and strontium sulfide (SrS:Eu) doped with europium. The green fluorescent substance 652 emits green light when excited by blue light. The peak of the wavelength of the light emitted from the green fluorescent substance 652 is 500-565 nm. For instance, the green fluorescent substance 652 comprises strontium thiogallate doped with europium (SrGa₂S₄:Eu) or calcium thiogallate doped with europium (CaGa₂S₄:Eu). The element doped in the red fluorescent substance 651 or the green fluorescent substance 652 is not limited to Eu and may be any one of Tb, Sm, Pr, Dy and Tm.

Unlike this embodiment, only one of the red fluorescent substance 651 and the green fluorescent substance 652 may comprise a sulfide-based fluorescent material. For instance, one of the red fluorescent substance 651 and the green fluorescent substance 652 may comprise a silicate-based fluorescent material.

As better shown in FIGS. 3 and 10, each frame 61 is bonded to the base 1. Specifically, the wiring portion 2 and the protective layer 3 are present between the frame 61 and the base 1. As shown in FIG. 7, as viewed in the thickness direction Z, the frame 61 surrounds the LED light source 4. The frame 61 is in direct contact with the insulating layer 5. Also, the frame 61 is in direct contact with the light-transmitting resin portion 63. The frame 61 functions to prevent a liquid material for forming the insulating layer 5 from flowing out to an undesired region. In this embodiment, the frame 61 also functions to cause a larger amount of light from the LED light source 4 to travel upward in FIG. 10 (functions as a reflector). For instance, the frame 61 is made of a white resin. Examples of white resin for forming the frame 61 include liquid crystal polymer and polybutylene terephthalate. In this embodiment, the frame 61 is made by molding.

Each frame 61 has an opening. Two LED light sources 4 are arranged in the opening of each frame 61. Each frame 61 has an inner surface 611 surrounding the LED light sources 4. The inner surface 611 defines the opening of the frame 61. In this embodiment, the inner surface 611 surrounds two LED light sources 4. Unlike this embodiment, each inner surface 611 may surround a single LED light source 4 or more than two LED light sources 4. Further, unlike this embodiment, only a single frame 61 may be provided which has a plurality of openings each surrounding a LED light source 4. As shown in FIG. 10, the inner surface 611 is inclined with respect to the thickness direction Z in such a manner that it becomes more distant from the LED light source 4 as viewed in the thickness direction Z as becoming more distant from the base 1 in the thickness direction Z. Part of the inner surface 611 is covered by the insulating layer 5.

As shown in FIG. 10, the light source bonding layer 71 bonds the LED light source 4 and the wiring portion 2 together. The light source bonding layer 71 is positioned between the LED light source 4 and the wiring portion 2. The light source bonding layer 71 is in direct contact with both of the LED light source 4 and the wiring portion 2. The light source bonding layer 71 is directly covered by the insulating layer 5. In this embodiment, the light source bonding layer 71 is in direct contact with the first layer 21 of the wiring portion 2. The light source bonding layer 71 is made of an electrically conductive material. Examples of the electrically conductive material for forming the light source bonding layer 71 include solder and Ag. Unlike this embodiment, the light source bonding layer 71 may be made of an insulating material.

As shown in FIG. 10, the frame bonding layer 72 bonds the frame 61 and the base 1 together. The frame bonding layer 72 functions to fix the frame 61 to the base 1. The frame bonding layer 72 is positioned between the frame 61 and the base 1. Specifically, the frame bonding layer 72 is in direct contact with the frame 61 and the protective layer 3. For instance, the frame bonding layer 72 may be made of a cured liquid adhesive. As the liquid adhesive, use may be made of a UV-adhesive or an acrylic adhesive.

Next, advantages of this embodiment are described below.

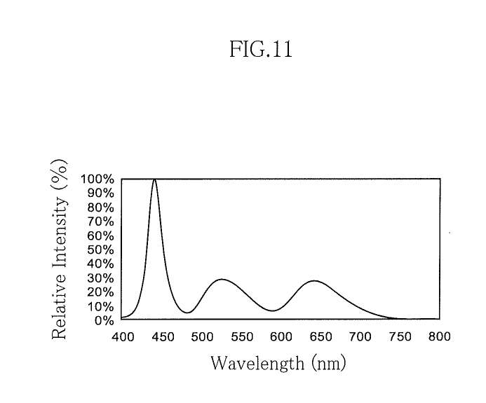

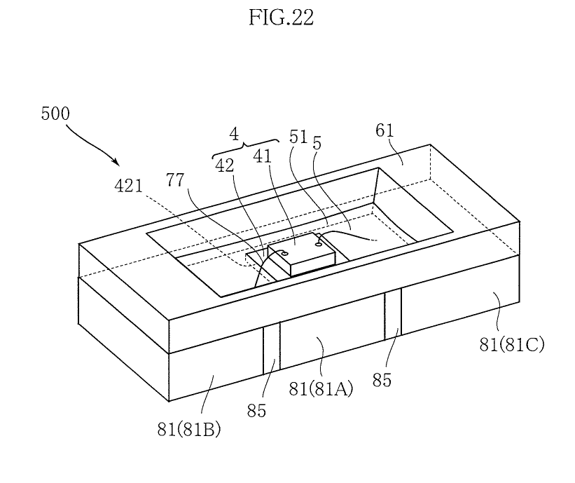

In the lighting device 100, the fluorescent substance 65 comprises a sulfide-based fluorescent material. Generally, when a sulfide-based fluorescent material is used, the spectrum of the light excited by the fluorescent material has a relatively small half-width. FIG. 11 shows the light emission spectrum of the light from the lighting device 100. In the light emission spectrum shown in this figure, the green range (wavelength: 500-565 nm) and the red range (wavelength: 625-740 nm) are more distinguishable from each other than in the light emission spectrum of the light from a conventional LED lighting apparatus (see FIG. 22). Moreover, in the light emission spectrum shown in FIG. 11, the intensity in the red range is higher than that in the light emission spectrum of the conventional LED lighting apparatus. The lighting device 100 that shows such a light emission spectrum can reproduce a wide range of color. This allows the liquid crystal display 800 to show various colors close to natural colors. Note that the lighting device 100 produces a considerably high NTSC ratio of 94.6%.

The lighting device 100 has an insulating layer 5 formed on the wiring portion 2 except some region at which the LED light source 4 is placed. With this arrangement, even when corrosive gas (sulfur gas) is generated from a sulfide-based fluorescent material, the insulating layer 5 prevents the gas from reaching the wiring portion 2. Thus, deterioration (sulfuration) of the wiring portion 2 is prevented, so that the reliability of the lighting device 100 is enhanced.

In this way, this embodiment provides a lighting device that has enhanced reliability and reproduces a wide range of color.

In this embodiment, the insulating layer 5 surrounds the LED light source 4 as viewed in the thickness direction Z. With this arrangement, the insulating layer 5 covers a large area of the wiring portion 2, which is suitable for preventing deterioration (sulfuration) of the wiring portion 2.

In this embodiment, the LED light source 4 has a chip base 42 on which the LED chip 41 is mounted. This structure allows the LED chip 41 to be spaced apart from the wiring portion 2.

Arranging the LED chip 41 spaced apart from the wiring portion 2 prevents the LED chip 41 from being covered by the insulating layer 5 covering the wiring portion 2. Since the LED chip 41 is not covered by the insulating layer 5, light emission from the light LED chip 41 is not hindered by the insulating layer 5. Thus, a decrease in the brightness of the light from the lighting device 100 is prevented.

In this embodiment, the chip base 42 has a side surface 421 oriented in the direction perpendicular to the thickness direction Z. The insulating layer 5 is made of a material having a reflectance higher than that of the material forming the chip base 42. The insulating layer 5 covers at least part of the side surface 421. This arrangement allows a large amount of light to be emitted from the light-transmitting resin portion 63, which results in an increase in the brightness of the light emitted from the lighting device 100. It is to be noted that the reflectance of the first layer 21 is lower when the first layer 21 is made of Au than when the first layer 21 is made of Ag. In this embodiment, however, since light is not to be reflected by the first layer 21, not only Ag, which has a relatively high reflectance, but also Au, which has a relatively low reflectance, can be used as the material for the first layer 21.

In this embodiment, the first layer 21 of the wiring portion 2 is in contact with the insulating layer 5. The first layer 21 is made of Ag or Au. With this arrangement, deterioration (sulfuration) of the first layer 21 is prevented even when the first layer 21 is made of Ag. Thus, the lighting device 100 has enhanced reliability. The reliability of the lighting device 100 is more enhanced when the first layer 21 is made of Au than when the first layer is made of Ag, because Au is less likely to deteriorate (sulfurate).

### First Variation of the First Embodiment

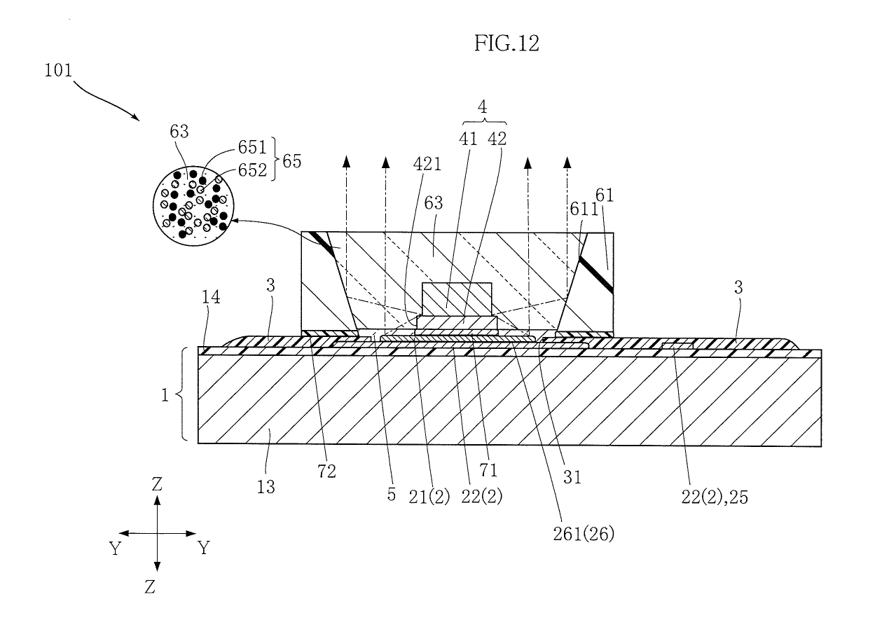

A first variation of the first embodiment of the present invention is described below with reference to FIG. 12.

FIG. 12 is a sectional view of a lighting device according to a first variation of the first embodiment of the present invention.

The lighting device 101 shown in the figure includes a base 1, a wiring portion 2, a protective layer 3, LED light sources 4, insulating layers 5, frames 61, light-transmitting resin portions 63, a fluorescent substance 65, light source bonding layers 71, frame bonding layers 72 and wires 77 (not shown in the figure of this variation).

The parts of the lighting device 101 excluding the insulating layer 5, i.e., the base 1, the wiring portion 2, the protective layer 3, the LED light sources 4, the frames 61, the light-transmitting resin portions 63, the fluorescent substances 6, the light source bonding layers 71, the frame bonding layers 72 and the wires 77 have the same structures as those of the lighting device 100, so that the explanation of these parts is omitted. The lighting device 101 is different from the lighting device 100 in material for forming the insulating layer 5.

In this variation again, the insulating layer 5 covers the wiring portion 2 except some region at which the LED light source 4 is placed. As viewed in the thickness direction Z, the insulating layer 5 surrounds the LED light source 4. The insulating layer 5 is in direct contact with the wiring portion 2. Specifically, the insulating layer 5 is in direct contact with the first layer 21 of the wiring portion 2.

In this variation, the insulating layer 5 is made of a material that transmits light from the LED light source 4. The insulating layer 5 is transparent. Examples of the material to form the insulating layer 5 include silver clay, which prevents sulfuration of the wiring portion 2. When silver clay is used as the material for the insulating layer 5, sulfuration of Ag is prevented even when the first layer 21 of the wiring portion 2 is made of Ag. The insulating layer 5 of this variation is thinner than the insulating layer 5 of the lighting device 100.

In this variation, the insulating layer 5 covers the light source bonding layer 71. The insulating layer 5 is in direct contact with the frame 61.

The advantages of this variation are described below.

In the lighting device 101, the fluorescent substance 65 comprises a sulfide-based fluorescent material. Further, the lighting device 101 has an insulating layer 5 that covers the wiring portion 2 except some region at which the LED light source 4 is placed. Thus, for the same reason as that described as to the lighting device 100, this variation provides a lighting device that has enhanced reliability and reproduces a wide range of color.

In this variation, the insulating layer 5 surrounds the LED light source 4 as viewed in the thickness direction Z. With this arrangement, the insulating layer 5 covers a large area of the wiring portion 2, which is suitable for preventing deterioration of the wiring portion 2.

In this variation, the first layer 21 of the wiring portion 2 is in contact with the insulating layer 5. The first layer 21 is made of Ag or Au. With this arrangement, deterioration (sulfuration) of the first layer 21 is prevented when the first layer 21 is made of Ag. This prevents a decrease in the reflectance of the first layer 21, and hence prevents a decrease in the brightness of the lighting device 101.

### Second Variation of the First Embodiment

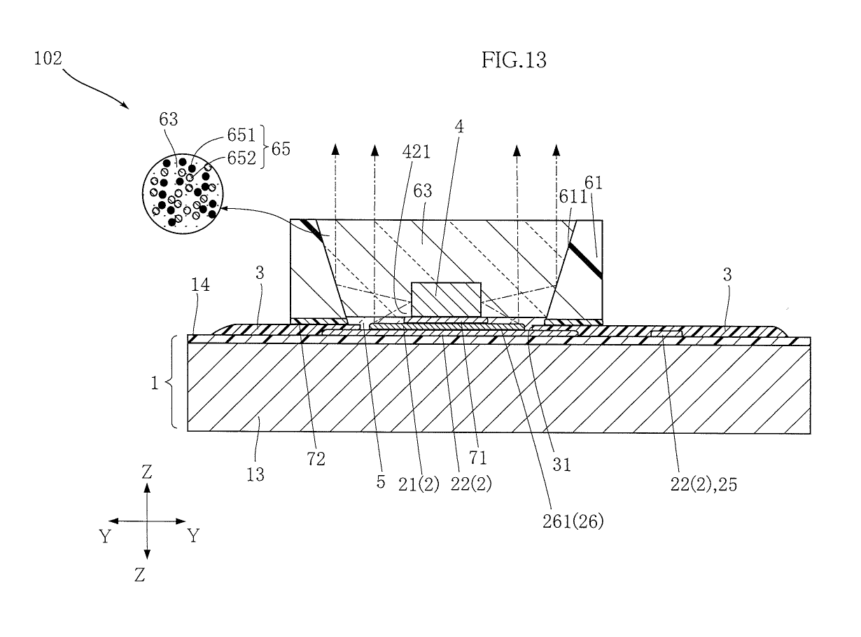

A second variation of the first embodiment of the present invention is described below with reference to FIG. 13.

FIG. 13 is a sectional view of a lighting device according to a second variation of the first embodiment of the present invention.

The lighting device 102 shown in the figure includes a base 1, a wiring portion 2, a protective layer 3, LED light sources 4, insulating layers 5, frames 61, light-transmitting resin portions 63, a fluorescent substance 65, light source bonding layers 71, frame bonding layers 72 and wires 77 (not shown).

The parts of the lighting device 102 excluding the LED light sources 4, i.e., the base 1, the wiring portion 2, the protective layer 3, the insulating layers 5, the frames 61, the light-transmitting resin portions 63, the fluorescent substance 65, the light source bonding layers 71, the frame bonding layers 72 and the wires 77 have the same structures as those of the lighting device 101, so that the explanation of these parts is omitted. The lighting device 102 is different from the lighting device 101 in structure of the LED light sources 4.

In this variation, each of the LED light sources 4 is a chip LED. That is, each LED light source 4 does not include a chip base 42 provided in the lighting device 100. Thus, the LED light source 4 of this variation corresponds to the LED chip 41 of the lighting device 101. In this variation again, the LED light source 4 is placed on the wiring portion 2. In this variation again, the LED light source 4, which is a chip LED, is in direct contact with the light source bonding layer 71. In this variation, the LED light source 4 and the wiring portion 2 are connected to each other via a wire 77. Unlike this variation, the LED light source 4 may be connected to the wiring portion 2 by flip-chip bonding.

The advantages of this variation are described below.

In the lighting device 102, the fluorescent substance 65 comprises a sulfide-based fluorescent material. Further, the lighting device 102 has an insulating layer 5 that covers the wiring portion 2 except some region at which the LED light source 4 is placed. Thus, for the same reason as that described as to the lighting device 100, this variation provides a lighting device that has enhanced reliability and reproduces a wide range of color.

In this variation, the insulating layer 5 surrounds the LED light source 4 as viewed in the thickness direction Z. With this arrangement, the insulating layer 5 covers a large area of the wiring portion 2, which is suitable for preventing deterioration of the wiring portion 2.

In this variation, the first layer 21 of the wiring portion 2 is in contact with the insulating layer 5. The first layer 21 is made of Ag or Au. With this arrangement, deterioration (sulfuration) of the first layer 21 is prevented when the first layer 21 is made of Ag. This prevents a decrease in the reflectance of the first layer 21, and hence prevents a decrease in the brightness of the lighting device 102.

### Second Embodiment

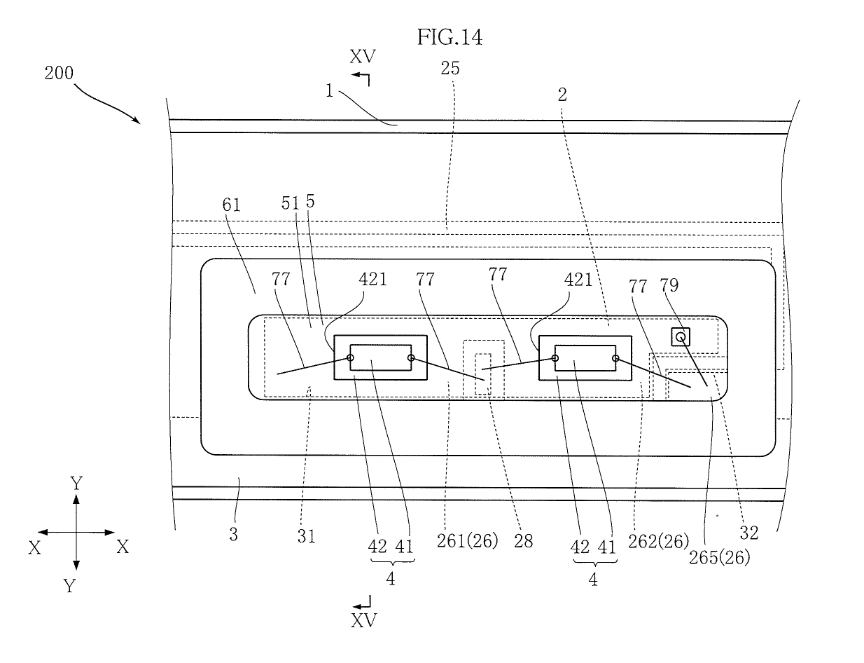

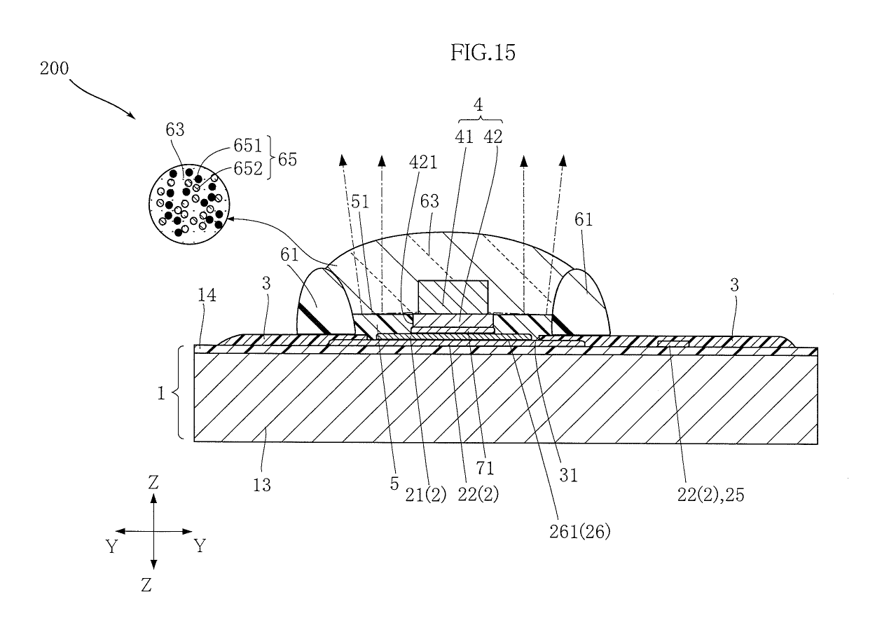

A second embodiment of the present invention is described below with reference to FIGS. 14 and 15.

FIG. 14 is a plan view of a lighting device according to a second embodiment of the present invention. FIG. 15 is a sectional view taken along lines XV-XV in FIG. 14.

The lighting device 200 shown in the figure includes a base 1, a wiring portion 2, a protective layer 3, LED light sources 4, insulating layers 5, frames 61, light-transmitting resin portions 63, a fluorescent substance 65, light source bonding layers 71 and wires 77.

The parts of the lighting device 200 excluding the frames 61 and the frame bonding layers 72, i.e., the base 1, the wiring portion 2, the protective layer 3, the LED light sources 4, the insulating layers 5, the light-transmitting resin portions 63, the fluorescent substance 65, the light source bonding layers 71 and the wires 77 have the same structures as those of the lighting device 100, so that the explanation of these parts is omitted. The lighting device 200 is different from the lighting device 100 in structure of the frame 61. In this embodiment, the frame 61 is formed by e.g. applying resin paste to the base 1. Thus, the lighting device 200 of this embodiment does not include a frame bonding layer 72.

The frame 61 is bonded to the base 1. Specifically, the wiring portion 2 and the protective layer 3 are present between the frame 61 and the base 1. As viewed in the thickness direction Z, the frame 61 surrounds the LED light source 4. The frame 61 is in direct contact with the insulating layer 5. Also, the frame 61 is in direct contact with the light-transmitting resin portion 63. The frame 61 functions to prevent a liquid material for forming the insulating layer 5 from flowing out to an undesired region. For instance, the frame 61 is made of a white resin. Examples of white resin for forming the frame 61 include silicone resin and acrylic resin.

The advantages of this embodiment are described below.

In the lighting device 200, the fluorescent substance 65 comprises a sulfide-based fluorescent material. Further, the lighting device 200 has an insulating layer 5 that covers the wiring portion 2 except some region at which the LED light source 4 is placed. Thus, for the same reason as that described as to the lighting device 100, this embodiment provides alighting device that has enhanced reliability and reproduces a wide range of color.

In this embodiment, the insulating layer 5 surrounds the LED light source 4 as viewed in the thickness direction Z. With this arrangement, the insulating layer 5 covers a large area of the wiring portion 2, which is suitable for preventing deterioration of the wiring portion 2.

In this embodiment, the LED light source 4 has a chip base 42 on which the LED chip 41 is mounted. For the same reason as described as to the lighting device 100, this arrangement prevents a decrease in the amount of light emitted from the lighting device 200.

In this embodiment, the chip base 42 has a side surface 421 oriented in the direction perpendicular to the thickness direction Z. The insulating layer 5 is made of a material having a reflectance higher than that of the material forming the chip base 42. The insulating layer 5 covers at least part of the side surface 421. This arrangement allows a large amount of light to be emitted from the light-transmitting resin portion 63, which results in an increase in the brightness of the light emitted from the lighting device 200. It is to be noted that the reflectance of the first layer 21 is lower when the first layer 21 is made of Au than when the first layer 21 is made of Ag. In this embodiment, however, since light is not to be reflected by the first layer 21, not only Ag, which has a relatively high reflectance, but also Au, which has a relatively low reflectance, can be used as the material for the first layer 21.

In this embodiment, the first layer 21 of the wiring portion 2 is in contact with the insulating layer 5. The first layer 21 is made of Ag or Au. With this arrangement, deterioration (sulfuration) of the first layer 21 is prevented even when the first layer 21 is made of Ag. Thus, the lighting device 200 has enhanced reliability. The reliability of the lighting device 200 is more enhanced when the first layer 21 is made of Au than when the first layer is made of Ag.

The frame 61 of this variation may be used as the frame 61 of the above-described lighting device 101 or the lighting device 102.

### Third Embodiment

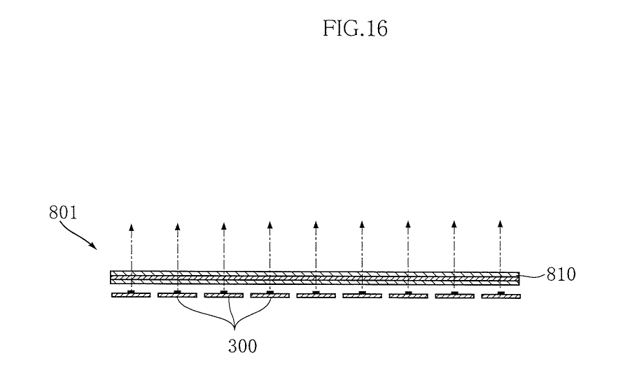

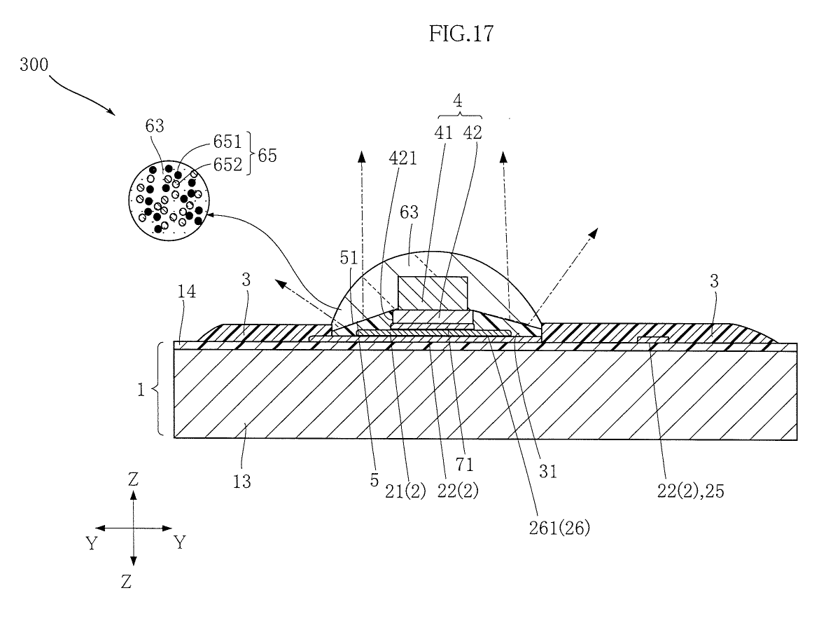

A third embodiment of the present invention is described below with reference to FIGS. 16 and 17.

FIG. 16 is a sectional view of a liquid crystal display according to a third embodiment of the present invention.

The liquid crystal display 801 shown in these figures includes a liquid crystal panel 810 and a plurality of lighting devices 300. In this embodiment, the liquid crystal display 801 does not include a light guide plate 820 provided in the liquid crystal display 800. The lighting devices 300 face the liquid crystal panel 810. The lighting devices 300 are arranged along one direction.

FIG. 17 is a sectional view of the lighting device shown in FIG. 16.

The lighting device 300 shown in the figure includes a base 1, a wiring portion 2, a protective layer 3, LED light sources 4, insulating layers 5, light-transmitting resin portions 63, fluorescent substances 65, light source bonding layers 71 and wires 77 (not shown).

The lighting device 300 does not include a frame 61 and a frame bonding layer 72. The base 1, the wiring portion 2, the protective layer 3, the LED light sources 4, the insulating layers 5, the light-transmitting resin portions 63, the fluorescent substance 65, the light source bonding layers 71 and the wires 77 of the lighting device 300 have the same structures as those of the lighting device 100, so that the explanation of these parts is omitted.

In this embodiment, the protective layer 3 functions to prevent a liquid material for forming the insulating layer 5 or a liquid material for forming a light-transmitting resin portion 63 from flowing out to an undesired region. As shown in FIG. 17, light from the lighting device 300, which includes a protective layer 3, is emitted to a wider range. Thus, although the liquid crystal display 801 does not include a light guide plate 820 provided in the liquid crystal display 800, white light is emitted to the entire surface of the liquid crystal panel 810.

The advantages of this embodiment are described below.

In the lighting device 300, the fluorescent substance 65 comprises a sulfide-based fluorescent material. Further, the lighting device 300 has an insulating layer 5 that covers the wiring portion 2 except some region at which the LED light source 4 is placed. Thus, for the same reason as that described as to the lighting device 100, this embodiment provides a lighting device that has enhanced reliability and reproduces a wide range of color.

In this embodiment, the insulating layer 5 surrounds the LED light source 4 as viewed in the thickness direction Z. With this arrangement, the insulating layer 5 covers a large area of the wiring portion 2, which is suitable for preventing deterioration of the wiring portion 2.

In this embodiment, the LED light source 4 has a chip base 42 on which the LED chip 41 is mounted. For the same reason as described as to the lighting device 100, this arrangement increases the brightness of the light emitted from the lighting device 300.

In this embodiment, the chip base 42 has a side surface 421 oriented in the direction perpendicular to the thickness direction Z. The insulating layer 5 is made of a material having a reflectance higher than that of the material forming the chip base 42. The insulating layer 5 covers at least part of the side surface 421. This arrangement allows a large amount of light to be emitted from the light-transmitting resin portion 63, which results in an increase in the brightness of the light emitted from the lighting device 300. It is to be noted that the reflectance of the first layer 21 is lower when the first layer 21 is made of Au than when the first layer 21 is made of Ag. In this embodiment, however, since light is not to be reflected by the first layer 21, not only Ag, which has a relatively high reflectance, but also Au, which has a relatively low reflectance, can be used as the material for the first layer 21.

In this embodiment, the first layer 21 of the wiring portion 2 is in contact with the insulating layer 5. The first layer 21 is made of Ag or Au. With this arrangement, deterioration (sulfuration) of the first layer 21 is prevented even when the first layer 21 is made of Ag. Thus, the lighting device 300 has enhanced reliability. The reliability of the lighting device 300 is more enhanced when the first layer 21 is made of Au than when the first layer is made of Ag.

The arrangement of this embodiment which does not include a frame 61 can be applied to the above-described lighting device 101 or lighting device 102.

### Fourth Embodiment

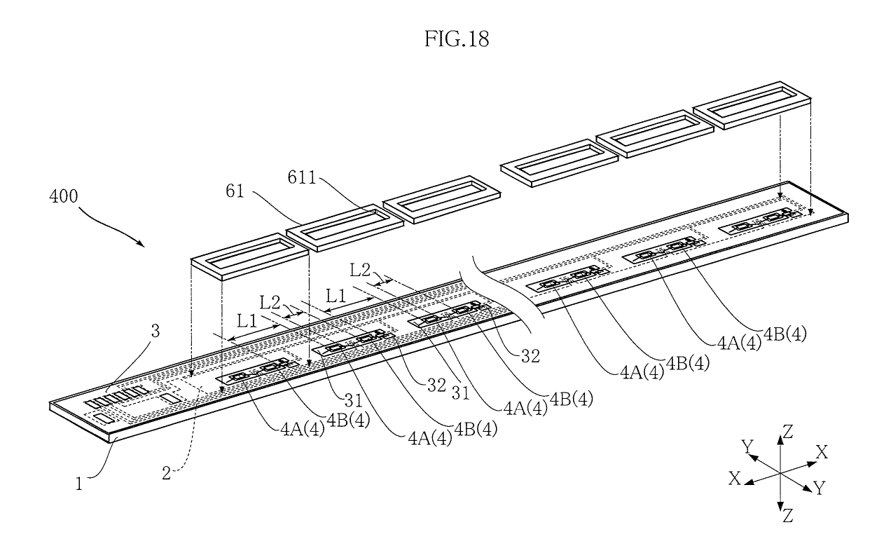

A fourth embodiment of the present invention is described below with reference to FIGS. 18-21.

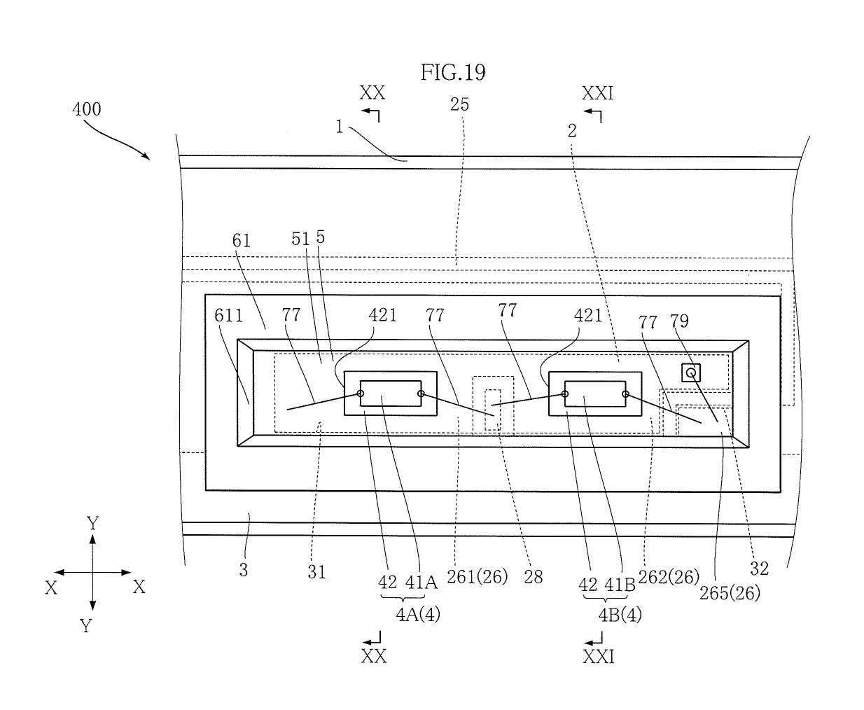

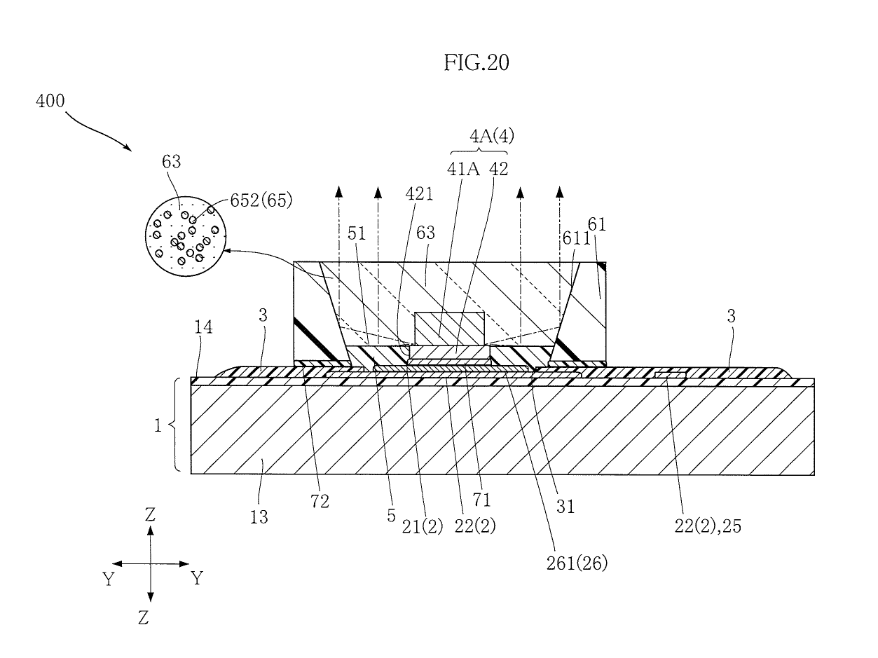

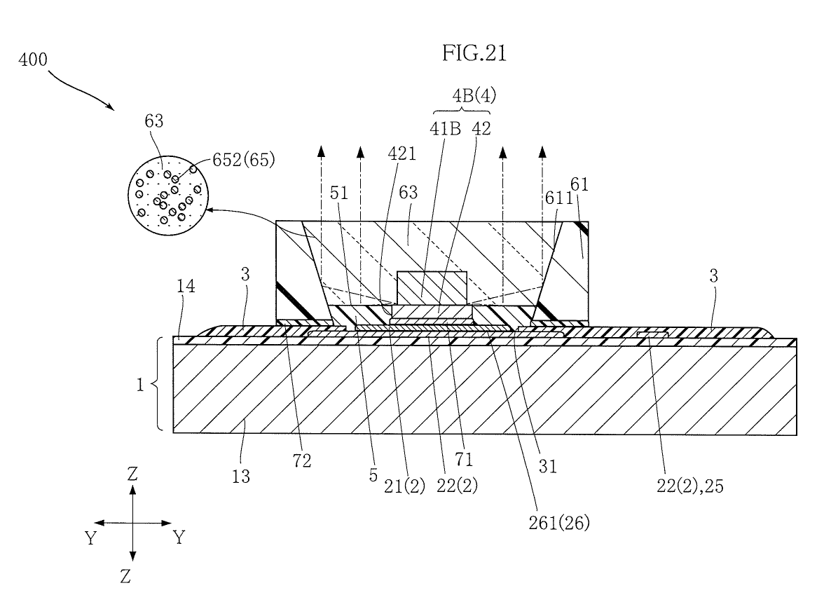

FIG. 18 is an exploded perspective view of a lighting device according to a fourth embodiment of the present invention. FIG. 19 is an enlarged plan view of part of the lighting device according to the fourth embodiment of the present invention. FIG. 20 is a sectional view taken along lines XX-XX in FIG. 19. FIG. 21 is a sectional view taken along lines XXI-XXI in FIG. 19.

The lighting device 400 shown in these figures includes a base 1, a wiring portion 2, a protective layer 3, LED light sources 4, insulating layers 5, frames 61, light-transmitting resin portions 63, a fluorescent substance 65, light source bonding layers 71, frame bonding layers 72 and wires 77.

The parts of the lighting device 400 excluding the LED light sources 4 and the fluorescent substance 65, i.e., the base 1, the wiring portion 2, the protective layer 3, the insulating layers 5, the frames 61, the light-transmitting resin portions 63, the light source bonding layers 71, the frame bonding layers 72 and the wires 77 have the same structures as those of the lighting device 100, so that the explanation of these parts is omitted.

The LED light sources 4 include a plurality of LED light sources 4A (first LED light sources) and a plurality of LED light sources 4B (second LED light sources). In this embodiment again, the LED light sources 4 (LED light sources 4A and 4B) are placed on the wiring portion 2.

Each of the LED light sources 4A emits blue light. As better shown in FIG. 20, each LED light source 4A includes an LED chip 41A and a chip base 42.

The LED chip 41A is a bear chip LED. In this embodiment, the LED chip 41A emits blue light. Since the chip base 42 of the LED light source 4A has the same structure as that of the lighting device 100, the explanation is omitted.

Each of the LED light source 4B emits red light. As better shown in FIG. 21, each LED light source 4B includes an LED chip 41B and a chip base 42.

The LED chip 41B is a bear chip LED. In this embodiment, the LED chip 41B emits red light. Since the chip base 42 of the LED light source 4B has the same structure as that of the lighting device 100, the explanation is omitted.

As shown in FIG. 18, in this embodiment, the LED light sources 4A and the LED light source 4B are alternately arranged along one direction. The distance between each of the LED light sources 4A and one of two LED light sources 4B adjacent to that LED light source 4A is distance L1. The distance between that LED light source 4A and the other one of the two adjacent LED light sources 4B is distance L2. The distance L1 and the distance L2 are different from each other. This arrangement is suitable for mixing the light from an LED light source 4A and the light from an LED light source 4B in a same set. To balance blue light and red light with each other, the size of the red LED light sources 4B is set equal to or larger than the size of the blue LED light sources 4A.

Unlike this embodiment, the LED light sources 4 may be arranged in such a manner that two LED light sources 4B and one LED light source 4A make one set, and the LED light source 4B is smaller than the LED light sources 4A. As compared with the case where a single LED light source 4B is used, using two LED light sources 4B allows the LEDs to be driven by a current that provides better light emission efficiency and hence realizes a higher brightness.

The LED light source 4A and the LED light source 4B are covered by the light-transmitting resin portion 63. As shown in FIG. 19, the insulating layer 5 is provided on the wiring portion 2 except the region at which the LED light source 4A is placed and the region at which the LED light source 4B is placed.

As shown in FIGS. 20 and 21, in this embodiment, the fluorescent substance 65 includes a green fluorescent substance 652. In the lighting device 400, the red fluorescent substance 651, which is used in the lighting device 100, is not used.

In this embodiment, the green fluorescent substance 652 comprises a sulfide-based fluorescent material. The green fluorescent substance 652 emits green light when excited by blue light. In this embodiment, the green fluorescent substance 652 emits green light when excited by the light emitted from the LED light source 4A. For instance, the green fluorescent substance 652 comprises strontium thiogallate doped with europium (SrGa₂S₄:Eu) or calcium thiogallate doped with europium (CaGa₂S₄:Eu). The green fluorescent substance 652 may be Ba(Al, Ga)₂S₄:Eu. The green fluorescent substance 652 may be (Sr, Ca, Ba) (Al, Ga)₂S₄:Eu.

Blue light from the LED light source 4A, red light from the LED light source 4B and green light from the green fluorescent substance 652 mix together, whereby white light is emitted from the lighting device 400.

The frame 61 is bonded to the base 1. Specifically, the wiring portion 2 and the protective layer 3 are present between the frame 61 and the base 1. As shown in FIG. 19, the frame 61 surrounds the LED light sources 4 (an LED light source 4A and an LED light source 4B). The frame 61 has an opening. Two LED light sources 4 (an LED light source 4A and an LED light source 4B) are arranged in the opening.

The advantages of this embodiment are described below.

In the lighting device 400, the fluorescent substance 65 comprises a sulfide-based fluorescent material. Further, the lighting device 400 has an insulating layer 5 provided on the regions except the region at which the LED light source 4A is placed and the region at which the LED light source 4B is placed. Thus, for the same reason as that described as to the lighting device 100, this embodiment provides a lighting device that has enhanced reliability and reproduces a wide range of color.

In this embodiment, the insulating layer 5 surrounds the LED light source 4A and the LED light source 4B as viewed in the thickness direction Z. With this arrangement, the insulating layer 5 covers a large area of the wiring portion 2, which is suitable for preventing deterioration (sulfuration) of the wiring portion 2.

In this embodiment, the LED light source 4A has a chip base 42 on which the LED chip 41A is mounted. Similarly, the LED light source 4B has a chip base 42 on which the LED chip 41B is mounted. For the same reason as described as to the lighting device 100, this arrangement prevents a decrease in the brightness of the light emitted from the lighting device 400.

In this embodiment, the chip base 42 has a side surface 421 oriented in the direction perpendicular to the thickness direction Z of the base 1. The insulating layer 5 is made of a material having a reflectance higher than that of the material forming the chip base 42. The insulating layer 5 covers at least part of the side surface 421. This arrangement allows a large amount of light to be emitted from the light-transmitting resin portion 63, which results in an increase in the brightness of the light emitted from the lighting device 400. It is to be noted that the reflectance of the first layer 21 is lower when the first layer 21 is made of Au than when the first layer 21 is made of Ag. In this embodiment, however, since light is not to be reflected by the first layer 21, not only Ag, which has a relatively high reflectance, but also Au, which has a relatively low reflectance, can be used as the material for the first layer 21.

In this embodiment, the first layer 21 of the wiring portion 2 is in contact with the insulating layer 5. The first layer 21 is made of Ag or Au. With this arrangement, deterioration (sulfuration) of the first layer 21 is prevented even when the first layer 21 is made of Ag. Thus, the lighting device 400 has enhanced reliability. The reliability of the lighting device 400 is more enhanced when the first layer 21 is made of Au than when the first layer is made of Ag, because Au is less likely to deteriorate (sulfurate).

In the lighting device 400, the LED light source 4A emits blue light, and the LED light source 4B emits red light. This arrangement enhances the intensity in the red range (625-740 nm) of the light from the lighting device 400. Thus, the lighting device can reproduce a wide range of color. As a result, the liquid crystal display 800 using the lighting device 400 shows various colors close to natural colors. Note that the lighting device 400 produces a considerably high NTSC ratio of 99.5%.

Though the lighting device 400 uses a green fluorescent substance 652 as the fluorescent substance 65, it does not use a red fluorescent substance 651. Reducing the amount of the fluorescent substance 65 used in the lighting device 400 allows a larger fraction of the light from the LED light source 4 to be emitted from the lighting device 400. This leads to enhancement of the light emission efficiency of the lighting device 400.

In the lighting device 400, a green fluorescent substance 652 is used to emit green light, and LED chips that emit green light are not used. LED chips that emit green light are relatively expensive. Thus, the lighting device 400 that does not use LED chips for emitting green light is suitable for avoiding an increase in the cost.

The arrangement of this embodiment in which the lighting device 100 includes LED light sources 4A and LED light sources 4B may be applied to the lighting device 101, the lighting device 102, the lighting device 200 or the lighting device 300.

### Fifth Embodiment

A fifth embodiment of the present invention is described below with reference to FIGS. 22-24.

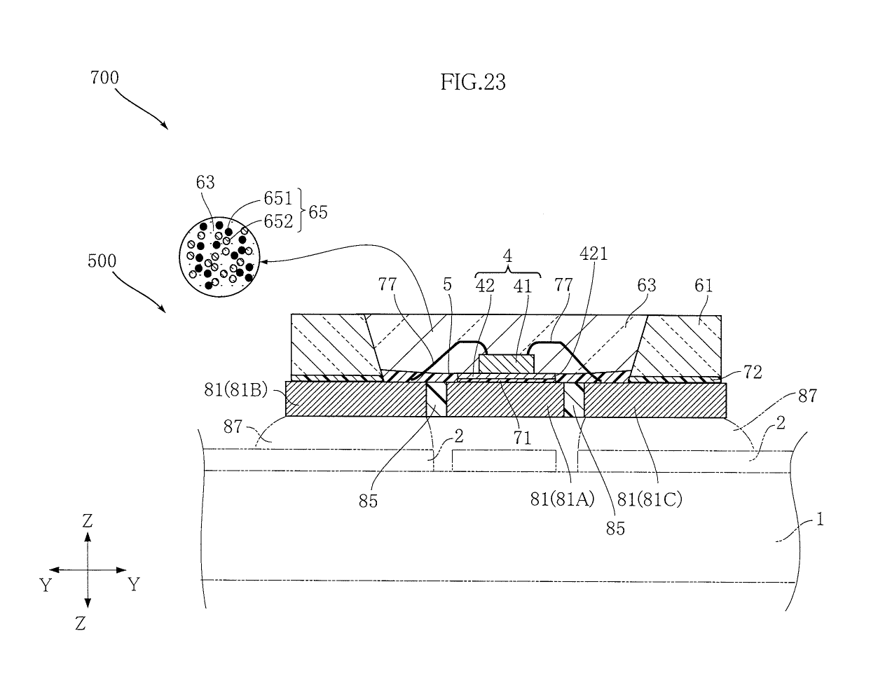

FIG. 22 is a perspective view of a lighting device according to a fifth embodiment of the present invention. FIG. 23 is a sectional view of the lighting device according to the fifth embodiment of the present invention.

The lighting device 500 shown in these figures includes a wiring portion 81, an insulating portion 85, an LED light source 4, an insulating layer 5, a frame 61, a light-transmitting resin portion 63, a fluorescent substance 65, a light source bonding layer 71, a frame bonding layer 72 and wires 77.

The lighting device 500 is different from the lighting device 100 in that only a single LED light source 4, a single insulating layer 5, a single frame 61, and a single light-transmitting resin portion 63 are provided, not plural. Except for this point, the LED light source 4, the insulating layer 5, the frame 61, the light-transmitting resin portion 63, the fluorescent substance 65, the light source bonding layer 71 and the wires 77 have the same structures as those of the lighting device 100, so that the explanation of these parts is omitted. The lighting device 500 is handled as a packaged product.

The wiring portion 81 is made of an electrically conductive material. In this embodiment, the wiring portion 81 is made of Cu. In this embodiment, the wiring portion 81 derives from a lead frame. A film of Ag may be provided on the surface of the wiring portion 81. The wiring portion 81 includes a portion 81A, a portion 81B and a portion 81C which are spaced apart from each other. On the portion 81A is placed the LED light source 4. On the portion 81B is bonded a wire 77. On the portion 81C is bonded another wire 77.

The insulating portion 85 is provided between the portion 81A and the portion 81B and between the portion 81A and the portion 81C. The insulating portion 85 prevents electrical conduction of the portion 81A and the portion 81B, and electrical conduction of the portion 81A and the portion 81C. In this embodiment, the wiring portion 81 and the insulating portion 85 provide a support member.

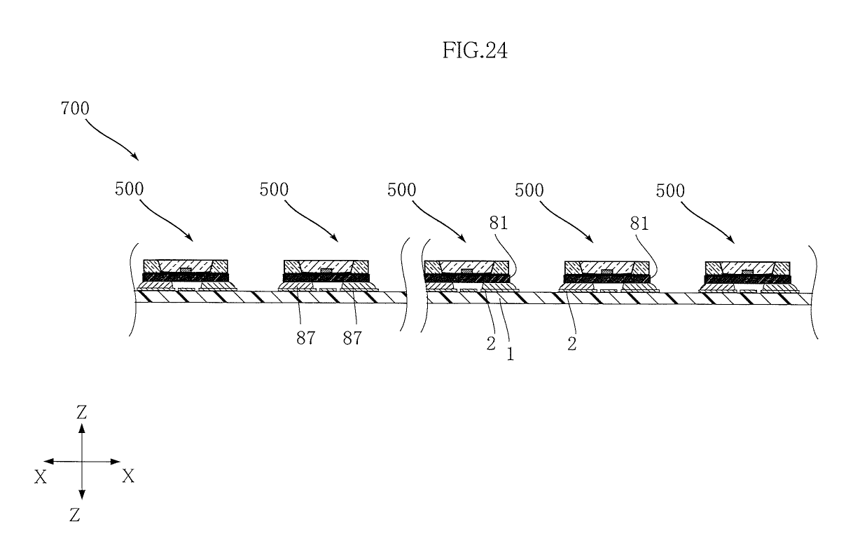

FIG. 24 is a sectional view of a light unit of this embodiment.

As shown in FIGS. 23 and 24, the light unit 700 includes a plurality of lighting devices 500 mounted on a base 1. (In FIG. 23, the parts other than the lighting device 500 are shown by imaginary lines.) An electrically conductive bonding layer 87 is present between the lighting device 500 and the base 1. The electrically conductive bonding layer 87 bonds the lighting device 500 and the base 1 together. Specifically, the electrically conductive bonding layer 87 bonds the wiring portion 81 of the lighting device 500 and the base 1 together. For instance, the electrically conductive bonding layer 87 is made of solder or silver paste.

The advantages of this embodiment are described below.

In the lighting device 500, the fluorescent substance 65 comprises a sulfide-based fluorescent material. The lighting device 500 has an insulating layer 5 provided on the wiring portion 81 except some region at which the LED light source 4 is placed. Thus, for the same reason as that described as to the lighting device 100, this embodiment provides a lighting device that has enhanced reliability and reproduces a wide range of color.

In this embodiment, the insulating layer 5 surrounds the LED light source 4 as viewed in the thickness direction Z. With this arrangement, the insulating layer 5 covers a large area of the wiring portion 81, which is suitable for preventing deterioration of the wiring portion 81.

In this embodiment, the LED light source 4 has a chip base 42 on which the LED chip 41 is mounted. For the same reason as described as to the lighting device 100, this arrangement increases the brightness of the light emitted from the lighting device 500.

In this embodiment, the chip base 42 has a side surface 421 oriented in the direction perpendicular to the thickness direction Z. The insulating layer 5 is made of a material having a reflectance higher than that of the material forming the chip base 42. The insulating layer 5 covers at least part of the side surface 421. This arrangement allows a large amount of light to be emitted from the light-transmitting resin portion 63, which results in an increase in the brightness of the light emitted from the lighting device 500.

The present invention is not limited to the foregoing embodiments. The specific structure of each part of the present invention can be varied in design in many ways.

In the above examples, a lighting device is used for a liquid crystal display. The present invention is not limited to this. For instance, the lighting device may be used as a light source of a fluorescent-lamp-like illuminator.

1. A lighting device comprising:
a support member including a wiring portion;
an LED light source placed on the wiring portion;
an insulating layer provided on the wiring portion except a region at which the LED light source is placed;
a light-transmitting resin portion covering the LED light source; and
a fluorescent substance dispersed in the light-transmitting resin portion;
wherein the fluorescent substance comprises a sulfide-based fluorescent material.

2. The lighting device according to claim 1, wherein the insulating layer surrounds the LED light source.

3. The lighting device according to claim 1, wherein the insulating layer is covered by the light-transmitting resin portion.

4. The lighting device according to claim 1, wherein the LED light source includes a chip base and an LED chip mounted on the chip base.

5. The lighting device according to claim 4, wherein the chip base comprises a sub-mount substrate made of Si.

6. The lighting device according to claim 4, wherein the chip base has a side surface oriented in a direction perpendicular to a thickness direction of the support member, the insulating layer is made of a material having a reflectance higher than a reflectance of a material forming the chip base, and the insulating layer covers at least part of the side surface.

7. The lighting device according to claim 6, wherein the insulating layer covers the entirety of the side surface.

8. The lighting device according to claim 4, wherein the insulating layer is spaced apart from the LED chip.

9. The lighting device according to claim 1, wherein the LED light source comprises an LED chip.

10. The lighting device according to claim 1, wherein the insulating layer includes a light reflective surface that is in direct contact with the light-transmitting resin portion.

11. The lighting device according to claim 1, wherein the insulating layer is white.

12. The lighting device according to claim 1, wherein the insulating layer is transparent.

13. The lighting device according to claim 1, wherein the wiring portion includes a first layer in contact with the insulating layer, and the first layer is made of Ag or Au.

14. The lighting device according to claim 13, wherein the wiring portion includes a second layer, the first layer is positioned between the second layer and the insulating layer, and the second layer is made of Cu.

15. The lighting device according to claim 1, further comprising a frame bonded to the support member and surrounding the LED light source.

16. The lighting device according to claim 15, wherein the insulating layer is in direct contact with the frame.

17. The lighting device according to claim 15, wherein the light-transmitting resin portion is in direct contact with the frame.

18. The lighting device according to claim 15, wherein the frame includes an inner surface surrounding the LED light source, and the inner surface is inclined with respect to the thickness direction in such a manner as to become more distant from the LED light source as viewed in the thickness direction as becoming more distant from the support member in the thickness direction.

19. The lighting device according to claim 15, further comprising a frame bonding layer that bonds the frame to the support member, wherein the frame bonding layer is in direct contact with the frame.

20. The lighting device according to claim 1, further comprising an insulating protective layer covering the wiring portion, the protective layer includes an opening for exposing the wiring portion, and the LED light source is arranged in the opening.

21. The lighting device according to claim 1, further comprising a wire that is in direct contact with both of the LED light source and the wiring portion, and at least part of the wire is directly covered by the insulating layer.

22. The lighting device according to claim 1, further comprising an LED bonding layer that bonds the LED light source and the wiring portion together, wherein the LED bonding layer is in direct contact with both of the LED light source and the wiring portion.

23. The lighting device according to claim 22, wherein the LED bonding layer is directly covered by the insulating layer.

24. The lighting device according to claim 1, wherein the support member is elongated in one direction, and the LED light source comprises a plurality of LED light sources arranged on the support member along the longitudinal direction of the support member.

25. The lighting device according to claim 1, wherein the fluorescent substance emits light of a different wavelength from a wavelength of light emitted from the LED light source when excited by light from the LED light source.

26. The lighting device according to claim 1, wherein the sulfide-based fluorescent material contains at least one sulfide selected from the group consisting of calcium sulfide (CaS), zinc sulfide (ZnS), strontium sulfide (SrS), strontium thiogallate (SrGa₂S₄) and calcium thiogallate (CaGa₂S₄).

27. The lighting device according to claim 1, wherein the sulfide-based fluorescent material that forms the fluorescent substance is a material doped with at least one element selected from the group consisting of Eu, Tb, Sm, Pr, Dy and Tm.

28. The lighting device according to claim 1, wherein the fluorescent substance includes a red fluorescent substance and a green fluorescent substance, and each of the red fluorescent substance and the green fluorescent substance comprises a sulfide-based fluorescent material.

29. The lighting device according to claim 28, wherein the red fluorescent substance comprises any one of calcium sulfide doped with europium (CaS:Eu), zinc sulfide doped with europium (ZnS:Eu) and strontium sulfide (SrS:Eu) doped with europium.

30. The lighting device according to claim 29, wherein the green fluorescent substance comprises strontium thiogallate doped with europium (SrGa₂S₄:Eu) or calcium thiogallate doped with europium (CaGa₂S₄:Eu).

31. The lighting device according to claim 1, wherein the LED light source emits blue light.

32. The lighting device according to claim 1, wherein, the LED light source serves as a first LED light source, the lighting device further comprises a second LED light source placed on the wiring portion, and the first LED light source emits blue light whereas the second LED light source emits red light.

33. The lighting device according to claim 32, wherein the insulating layer is provided on the wiring portion except a region at which the first LED light source is placed and a region at which the second LED light source is placed.

34. The lighting device according to claim 32, wherein the fluorescent substance includes a green fluorescent substance, and the green fluorescent substance comprises a sulfide-based fluorescent material.

35. The lighting device according to claim 34, wherein the green fluorescent substance comprises strontium thiogallate doped with europium (SrGa₂S₄:Eu) or calcium thiogallate doped with europium (CaGa₂S₄:Eu).

36. The lighting device according to claim 32, wherein the light-transmitting resin portion covers the second LED light source.

37. The lighting device according to claim 1, wherein the support member includes a base on which the wiring portion is provided, the base includes an electrically conductive substrate and an insulating film formed on the substrate, and the wiring portion is formed on the insulating film.

38. A light unit comprising:
a lighting device as set forth in claim 1;
a base; and
an electrically conductive bonding layer that is provided between the support member and the base and bonds the support member and the base together.

39. The light unit according to claim 38, wherein the base is elongated in one direction.

40. The light unit according to claim 38, wherein the electrically conductive bonding layer is solder or silver paste.

41. A liquid crystal display comprising:
a lighting device as set forth in claim 1; and
a liquid crystal panel for forming an image by selectively transmitting light emitted from the lighting device.

42. The liquid crystal display according to claim 41, further comprising a light guide plate including a light incident surface, a reflective surface and a light emitting surface, wherein the light incident surface spreads along a plane parallel to a thickness direction of the light guide plate and faces the lighting device, the reflective surface reflects light traveling from the light incident surface toward the light emitting surface, and the light emitting surface allows light reflected by the reflective surface to be emitted toward the liquid crystal panel.

43. The liquid crystal display according to claim 41, wherein the lighting device comprises a plurality of lighting devices, and the lighting devices are arranged along one direction and face the liquid crystal panel.
